(19) United States
(12) Patent Application Publication
(10) Pub. No.: US 2025/0372810 A1
(43) Pub. Date: Dec. 4, 2025

(54) LI-ION BATTERY MODULE FOR PREVENTING THERMAL RUNAWAY SPREADING

(71) Applicant: C-TECH.United Corporation, New Taipei City (TW)

(72) Inventors: CHIH-KUN YANG, New Taipei City (TW); CHENG CHANG CHIU, New Taipei City (TW)

(73) Assignee: C-TECH.United Corporation, New Taipei City (TW)

(21) Appl. No.: 18/917,047

(22) Filed: Oct. 16, 2024

(30) Foreign Application Priority Data
May 31, 2024 (TW) 113120219

(51) Int. Cl. H01M 50/383; H01M 10/0525; H01M 10/653; H01M 50/213; H01M 50/367

(52) U.S. Cl. CPC H01M 50/383; H01M 10/0525; H01M 10/653; H01M 50/213; H01M 50/367

(57) ABSTRACT

Disclosed is a Li-ion battery module for preventing thermal runaway spreading, used in a chassis, comprising: a battery pack, including a plurality of cells; a thermally conductive plastic component having a plurality of openings; a separating plate, wherein an air flow path is formed between the separating plate and the chassis, and a plurality of vent holes of the separating plate are connected with the air flow path; a flame-retardant expandable member disposed between the thermally conductive plastic component and the separating plate; and a flow-limiting member, having a circuitous flow path so that high-temperature substances released by the cells in thermal runaway will pass through the openings, causing the flame-retardant expandable member to expand and block the opening, thereby preventing flames and sparks from spreading to the exterior of the chassis, and ensuring the safety of surrounding equipment and personnel.

### FIELD OF THE INVENTION

The present invention relates to a battery module, and more particularly relates to a Li-ion battery module for preventing thermal runaway spreading.

### BACKGROUND OF THE INVENTION

The demand for high energy density energy storage systems is on the rise, such as energy storage for electrical grids, backup power for data centers and electric vehicles. The battery modules of these energy storage systems have various safety requirements based on the environment in which they are used. When thermal runaway occurs in the cells of the battery modules, high-temperature flammable gases and flames are generated. One of the safety requirements for the battery modules is to effectively prevent flames and sparks from spreading out of the chassis that accommodates the battery module during thermal runaway. The above thus ensures the overall safety of surrounding devices and personnel.

### SUMMARY OF THE INVENTION

Accordingly, one objective of the present invention is to provide a Li-ion battery module for preventing thermal runaway spreading, which prevents flames and sparks from spreading out of the chassis that accommodates the battery module when thermal runaway occurs.

In order to overcome the technical problems in prior art, the present invention provides a Li-ion battery module for preventing thermal runaway spreading, used in a chassis, comprising: a battery pack, including a plurality of cells; a thermally conductive plastic component disposed at the battery pack and having a plurality of openings; a separating plate, wherein the thermally conductive plastic component is disposed between the separating plate and the battery pack, an air flow path is formed between the separating plate and the chassis, and a plurality of vent holes of the separating plate are connected with the air flow path; a flame-retardant expandable member disposed between the thermally conductive plastic component and the separating plate; and a flow-limiting member, having a circuitous flow path, one end of the circuitous flow path being connected with the air flow path, and the other end of the circuitous flow path being connected with an internal space of the chassis, wherein positive terminals of the cells are provided to align with the plurality of openings and the flame-retardant expandable member such that high-temperature substances released by the cells in thermal runaway are to pass through the openings and to have the flame-retardant expandable member to expand and block the opening.

In one embodiment of the present invention, the Li-ion battery module is provided, wherein the thermally conductive plastic component is two in number, the positive terminals of some of the cells are provided to align with the openings of one of the thermally conductive plastic components, and the positive terminals of the other cells are provided to align with the openings of the other thermally conductive plastic component.

In one embodiment of the present invention, the Li-ion battery module is provided, wherein the flow-limiting member is two in number, one of the flow-limiting members is disposed at an inlet side of the air flow path, and the other flow-limiting member is disposed at an outlet side of the air flow path.

In one embodiment of the present invention, the Li-ion battery module is provided, wherein an internal air flow path is formed between the thermally conductive plastic component and the separating plate, and said one end of the circuitous flow path connected with the air flow path is connected with the internal air flow path.

In one embodiment of the present invention, the Li-ion battery module is provided, wherein the openings of the thermally conductive plastic component are arranged in a non-overlapping manner with respect to the vent holes of the separating plate.

In one embodiment of the present invention, the Li-ion battery module is provided further comprising a flame-retardant sheet covering the battery pack and the thermally conductive plastic component.

With the technical means adopted by the Li-ion battery module of the present invention, since thermal runaway of the cell often ejects various substances from the positive terminal, the present invention provides the positive terminal of the cell which aligns with the thermally conductive plastic component and the flame-retardant expandable member. Accordingly, when thermal runaway of the cell occurs, the high-temperature substances ejecting from the positive terminal of the thermal-runaway cell will pass through the opening, thus it causes the flame-retardant expandable member to expand and block the opening. The high-temperature substances then flow through the vent holes into the gas flow channel, where the circuitous flow path of the flow-limiting member provides a long path. Such multi-faceted means prevents flames and sparks from spreading out of the chassis, thereby protecting the safety of surrounding personnel and devices.

### BRIEF DESCRIPTION OF THE DRAWINGS

FIG. 1 is a schematic perspective drawing illustrating a Li-ion battery module according to an embodiment of the present invention;

FIG. 2 is a schematic perspective drawing illustrating the Li-ion battery module according to the embodiment of the present invention;

FIG. 3 is a schematic exploded drawing illustrating the Li-ion battery module according to the embodiment of the present invention;

FIG. 4 is a schematic top view illustrating a separating plate of the Li-ion battery module according to the embodiment of the present invention; and

FIG. 5 is a schematic cross-sectional view illustrating a flow-limiting element of the Li-ion battery module according to the embodiment of the present invention.

### DETAILED DESCRIPTION OF THE PREFERRED EMBODIMENTS

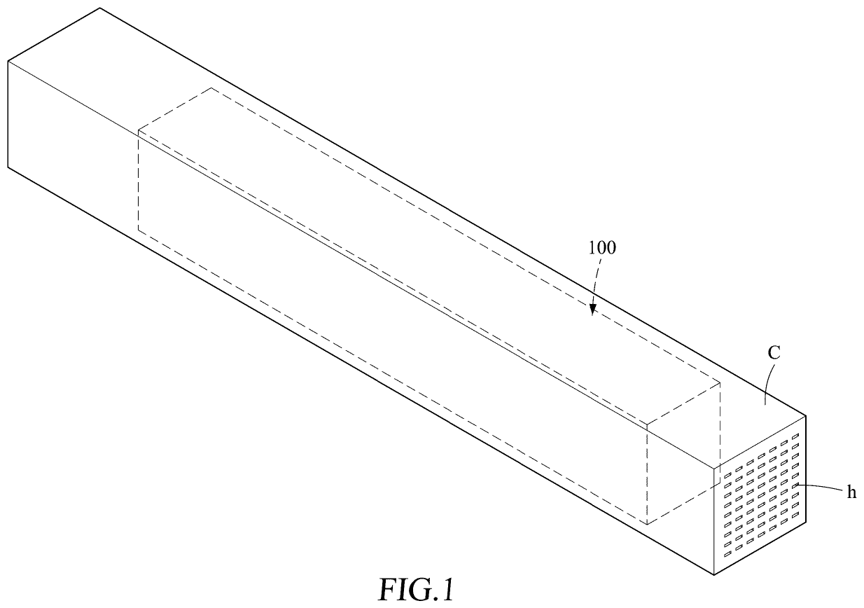

The preferred embodiments of the present invention are described in detail below with reference to FIG. 1 to FIG. 5. The description is used for explaining the embodiments of the present invention only, but not for limiting the scope of the claims.

As shown in FIG. 1, a Li-ion battery module for preventing thermal runaway spreading 100 according to one embodiment of the present invention is used in a chassis C. The chassis C and the Li-ion battery module for preventing thermal runaway spreading 100 inside the chassis C are cooled by a fan (not shown) providing active cooling with a predetermined airflow direction d. The chassis C is provided with ventilation holes h on both sides in the airflow direction d.

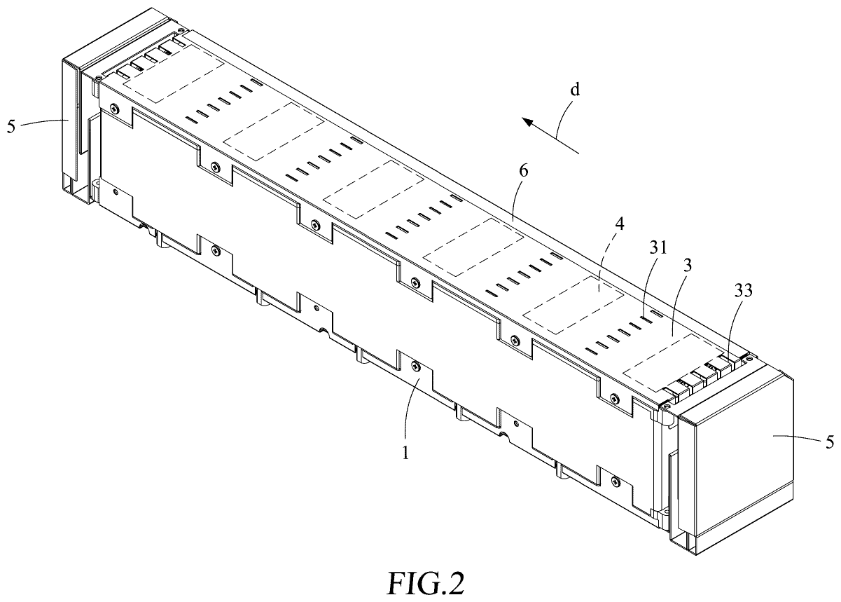

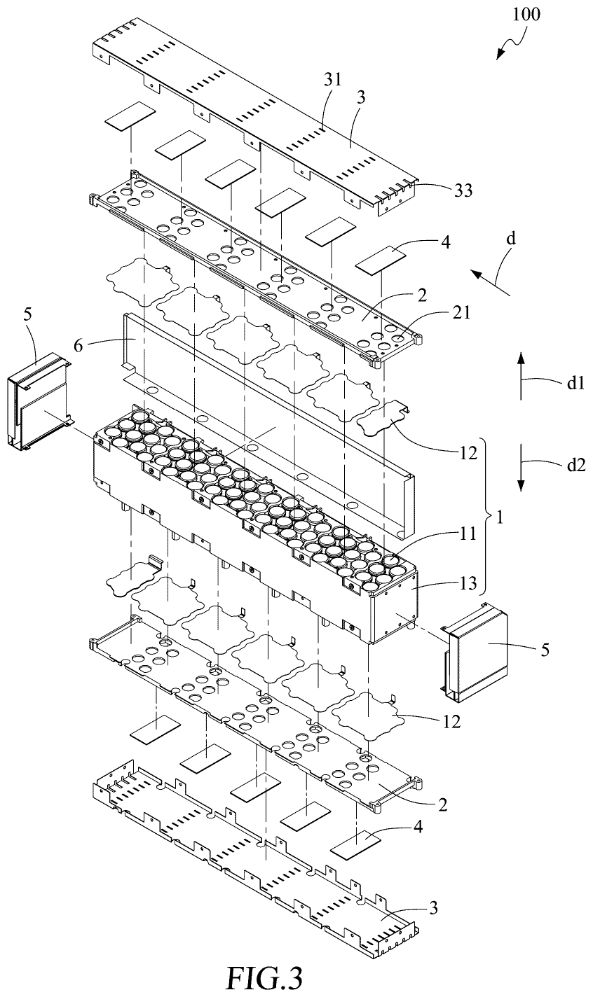

As shown in FIGS. 2 and 3, the Li-ion battery module for preventing thermal runaway spreading 100 includes: a battery pack 1, a thermally conductive plastic component 2, a separating plate 3, a flame-retardant expandable member 4, a flow-limiting member 5, a flame-retardant sheet 6, and a battery management system (BMS; not shown).

As shown in FIG. 3, the battery pack 1 includes a plurality of cells 11, metal conductive sheets 12, and a cell holder 13.

The cells 11 are disposed in cell accommodating holes of the cell holder 13 and are connected in parallel and/or series through the metal conductive sheets 12. The metal conductive sheets 12 are nickel sheets. The battery management system is for managing the charging and discharging of the cells 11.

As shown in FIG. 3, in this embodiment, the positive terminals of some of the cells 11 are oriented in a first direction d1 and face one of the thermally conductive plastic components 2. The positive terminals of the other cells 11 are oriented in a second direction d2 and face the other thermally conductive plastic component 2. The first direction d1 and the second direction d2 are opposite, and preferably, the first direction d1 and the second direction d2 are perpendicular to the airflow direction d. In other embodiments, all cells may face the same direction, with one thermally conductive plastic component 2 provided at the positive terminal side of the cells correspondingly.

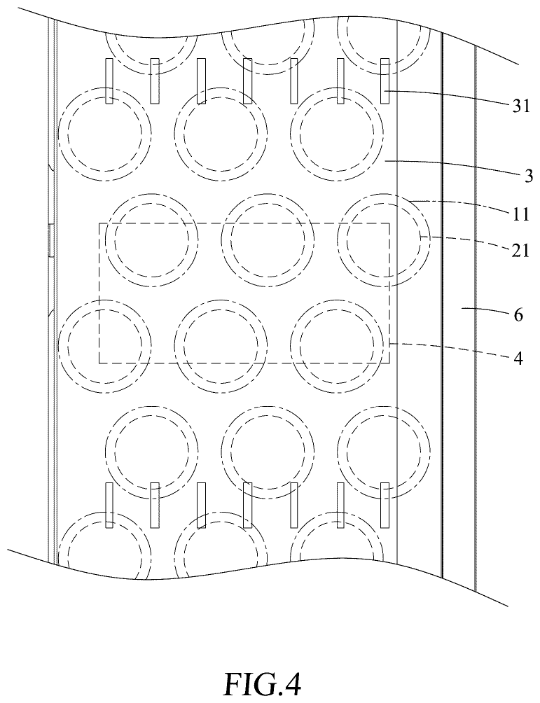

As shown in FIG. 3 and FIG. 4, in the Li-ion battery module for preventing thermal runaway spreading 100 according to the embodiment of the present invention, the thermally conductive plastic component 2 is arranged on the battery pack 1. In this embodiment, the thermally conductive plastic component 2 is made of high thermal conductivity plastic such as Nytex, enabling rapid dispersion of heat from high-temperature materials produced during the thermal runaway and is flame-retardant.

As shown in FIG. 4, the cells 11 indicated by dashed lines indicate the cells whose positive terminals are oriented outward the plane of the paper, and the cells 11 indicated by chain-dot lines indicate the cells whose positive terminals are oriented inward the plane of the paper. The thermally conductive plastic component 2 has a plurality of openings 21. The number of the openings corresponds to the number of the cells 11, and the position of the openings corresponds to the positions of the positive terminals of the cells 11, thereby allowing substances ejected during thermal runaway to pass through the openings 21 and enter the space between the separating plate 3 and the thermally conductive plastic component 2.

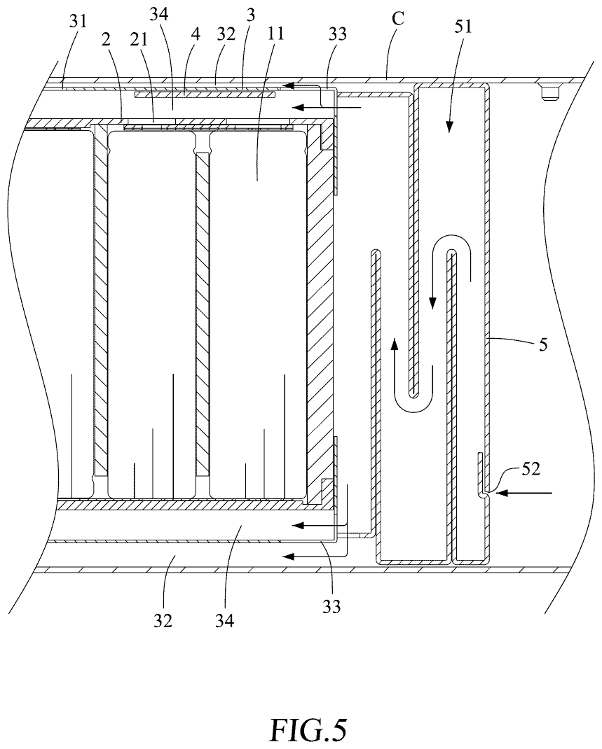

As shown in FIGS. 4 and 5, the thermally conductive plastic component 2 is disposed between the separating plate 3 and the battery pack 1. The separating plate 3 is a metal plate that maintains its shape at high temperature. An air flow path 32 is formed between the separating plate 3 and the chassis C. An internal air flow path 34 is formed between the thermally conductive plastic component 2 and the separating plate 3. A plurality of vent holes 31 of the separating plate 3 are connected with the air flow path 32 and the internal air flow path 34. The separating plate 3 is provided with heat dissipation holes 33 at both front and rear ends. The heat dissipation holes 33 face the front and the rear flow-limiting members 5 and connected with the air flow path 32 and the internal air flow path 34 so that gas can enter the internal air flow path 34 through the heat dissipation holes 33 to dissipate heat of the battery pack 1.

In this embodiment, the vent holes 31 are long and narrow holes along the air flow direction d, so that the shape of the flame passing through the vent holes 31 is thin and difficult to extend.

As shown in FIGS. 3 to 5, the flame-retardant expandable member 4 is disposed between the thermally conductive plastic component 2 and the separating plate 3, and the positive terminals of the cells 11 are provided to align with the plurality of openings 21 and the flame-retardant expandable member 4. The flame-retardant expandable member 4 overlaps with the openings 21. Specifically, the flame-retardant expandable member 4 is disposed on the separating plate 3. A reaction temperature of the flame-retardant expandable member 4 is higher than an operating temperature of the cells 11 but lower than a temperature of the products of the thermal runaway of the cells 11. As a result, when the high-temperature substances released by the thermal runaway cells 11 contact the flame-retardant expandable member 4, the volume of the flame-retardant expandable member 4 expands dozens of times, blocking the openings 21 of the thermally conductive plastic component 2.

As shown in FIG. 5, the flow-limiting member 5 has a circuitous flow path 51. A wall portion of the flow-limiting member 5 is a metal baffle. One end of the circuitous flow path 51 is connected with the air flow path 32 and a heat dissipation hole 33, and the other end of the circuitous flow path 51 is connected with an internal space of the chassis C. In this embodiment, both the inlet and outlet sides of the air flow path 32 are installed with one flow-limiting member 5. FIG. 5 illustrates the flow-limiting member 5 at the inlet side of the air flow path 32, with the arrow indicating the predetermined airflow path.

As shown in FIG. 4, in the Li-ion battery module 100 according to the embodiment of the present invention, the plurality of openings 21 of the thermally conductive plastic component 2 are arranged in a non-overlapping manner with respect to the plurality of vent holes 31 of the separating plate so that the high-temperature substances released by the cells in thermal runaway must pass through a winding path before entering the air flow path 32.

The flame-retardant sheet 6 can be YT516 aramid paper or Mylar film, having insulation and flame-retardant properties. As shown in FIG. 3, the flame-retardant sheet 6 covers sides of the battery pack and sides of the thermally conductive plastic component.

In summary, as shown in FIG. 5, the positive terminal of cell 11 points upward, with metal conductive sheets 12, the thermally conductive plastic component 2 and its openings 21, the flame-retardant expandable member 4, the separating plate 3 and its vent holes 31, and chassis C arranged sequentially above the positive terminal. Therefore, when thermal runaway of the cell 11 occurs, the high-temperature substances ejected from the positive terminal of the thermal-runaway cell 11 will enter the internal air flow path 34 through the opening 21, then the openings 21 of the thermally conductive plastic component will be blocked by the flame-retardant expandable member 4, and the high-temperature substances travel through the long path provided by the circuitous flow path 51 of the flow-limiting member 5, thereby preventing flames and sparks from spreading outside the chassis C through multi-faceted means.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A Li-ion battery module for preventing thermal runaway spreading, used in a chassis, comprising:
a battery pack, including a plurality of cells;
a thermally conductive plastic component disposed at the battery pack and having a plurality of openings;
a separating plate, wherein the thermally conductive plastic component is disposed between the separating plate and the battery pack, an air flow path is formed between the separating plate and the chassis, and a plurality of vent holes of the separating plate are connected with the air flow path;
a flame-retardant expandable member disposed between the thermally conductive plastic component and the separating plate; and
a flow-limiting member, having a circuitous flow path, one end of the circuitous flow path being connected with the air flow path, and the other end of the circuitous flow path being connected with an internal space of the chassis,
wherein positive terminals of the cells are provided to align with the plurality of openings and the flame-retardant expandable member such that high-temperature substances released by the cells in thermal runaway are to pass through the openings and to have the flame-retardant expandable member to expand and block the opening.

2. The Li-ion battery module as claimed in claim 1, wherein the thermally conductive plastic component is two in number, the positive terminals of some of the cells are provided to align with the openings of one of the thermally conductive plastic components, and the positive terminals of the other cells are provided to align with the openings of the other thermally conductive plastic component.

3. The Li-ion battery module as claimed in claim 1, wherein the flow-limiting member is two in number, one of the flow-limiting members is disposed at an inlet side of the air flow path, and the other flow-limiting member is disposed at an outlet side of the air flow path.

4. The Li-ion battery module as claimed in claim 1, wherein an internal air flow path is formed between the thermally conductive plastic component and the separating plate, and said one end of the circuitous flow path connected with the air flow path is connected with the internal air flow path.

5. The Li-ion battery module as claimed in claim 1, wherein the openings of the thermally conductive plastic component are arranged in a non-overlapping manner with respect to the vent holes of the separating plate.

6. The Li-ion battery module as claimed in claim 1, further comprising a flame-retardant sheet covering the battery pack and the thermally conductive plastic component.
